(19) United States
(12) Patent Application Publication
(10) Pub. No.: US 2003/0147640 A1
(43) Pub. Date: Aug. 7, 2003

(54) System and method for capturing and embedding high-resolution still image data into a video data stream

(76) Inventors: James S. Voss, Fort Collins, CO (US); James W. Owens, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 10/068,995

(22) Filed: Feb. 6, 2002

(51) Int. Cl. G03B 17/24

(52) U.S. Cl. 396/310; 382/276

(57) ABSTRACT

Systems for capturing and embedding high-resolution still image data in a sequence of video data are disclosed. An exemplar system comprises an image capture element for capturing a sequence of video data during a first mode of operation, the sequence of video data captured at a first resolution, a user interface for entering into a second mode of operation, the second mode of operation being at a second resolution, the second resolution being greater than the first resolution, and a memory for storing data captured at the second resolution. Corresponding exemplar methods and computer readable media are also disclosed.

### BACKGROUND OF THE INVENTION

1. Field of the Invention

The invention relates generally to electronic image capture, and, more particularly, to a system for capturing and embedding high-resolution still image data into a video data stream.

2. Related Art

Digital photography is becoming more and more popular due to the availability of affordable digital cameras. There are generally two types of products used to capture digital media: digital cameras and digital video recorders. Digital cameras generally capture still images and are sometimes referred to as digital still cameras, while digital video recorders capture video images at a frame rate of some number of frames per second. This results in lower resolution than a digital still camera. For example, conventional motion pictures are typically captured at a frame rate of 24 frames per second.

Digital video recorders are available in many formats. All digital video recorders generally include some type of lens, through which light is directed to an image capture element. The image capture element may be a charge coupled device (CCD), a complementary metal oxide semiconductor (CMOS) sensor, or some other type of image capture element. Regardless of the type of image capture element, the image capture element generally comprises a matrix of light collecting elements, generally referred to as picture elements, or pixels. A typical digital video recorder may include an image sensor having tens of thousands, hundreds of thousands, or millions of pixels.

Digital video recorders typically operate at a frame rate of greater than 15 frames per second (f/s). Such a frame rate generally allows the information captured by the pixels in the image sensor to provide adequate quality for capturing, recording, and playing back video image data.

Digital still cameras share many features with digital video cameras. For example, a digital still camera also includes a lens, through which light is directed to an image capture element. Similar to that described above with respect to digital video cameras, the image capture element for a digital still camera can be a CCD element, a CMOS sensor, or some other type of light capturing apparatus. Today's digital still cameras also include image sensors having millions of pixels or more.

However, the distinction between digital video cameras and digital still cameras is beginning to blur. For example, many digital still cameras can capture images at frame rates approaching video and many digital video cameras offer the option of capturing still images. The distinction between digital still cameras and digital video recorders generally occurs at approximately 15 f/s. Generally, a frame rate greater than 15 frames per second is considered “video” and a frame rate lower than 15 frames per second, but greater than one frame per second is considered “burst mode,” or “bursting,” which is sometimes also referred to as “paparazzi mode.”

Unfortunately, using a digital video recorder to capture still images includes drawbacks. For example, when using a digital video recorder to obtain a still image having a quality sufficient to provide what is considered to be a reasonable quality print and a reasonably sized (on the order of 8″×10″) enlargement, a resolution higher than that required for video image data capture is typically needed. For example, for an 8×10 photographic quality still image, approximately 2 million (mega) pixel resolution is considered adequate. This resolution equates to an image capture element having approximately 2048 pixels by 1024 pixels. In a typical digital video recorder, this large number of pixels cannot be accessed and read at a speed sufficient to provide the needed resolution for an adequate quality printed still image.

Currently, some digital video recorders include the feature of addressing only a portion of the available pixels in the image sensor, thus enabling increased resolution, but at the expense of total image size. This reduction in image capture area inhibits the reproduction of photographic sized images having adequate quality.

Therefore, it would be desirable to have a digital video recorder that is capable of capturing still images at a resolution sufficient to provide a high quality printed image.

### SUMMARY

A system and method for capturing and embedding high-resolution still image data in a sequence of video data is disclosed. The system comprises an image capture element for capturing a sequence of video data during a first mode of operation, the sequence of video data captured at a first resolution, a user interface for entering into a second mode of operation, the second mode of operation being at a second resolution, the second resolution being greater than the first resolution, and a memory for storing data captured at the second resolution.

The method for capturing and embedding high-resolution still image data in a sequence of video data, comprises capturing a sequence of video data during a first mode of operation, the sequence of video data captured at a first resolution, entering into a second mode of operation, the second mode of operation being at a second resolution, the second resolution being greater than the first resolution, capturing data at the second resolution, and storing the data captured at the second resolution.

Other systems, methods, features, and advantages of the present invention will be or become apparent to one with ordinary skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

Embodiments of the invention, as defined in the claims, can be better understood with reference to the following drawings. The components within the drawings are not necessarily to scale relative to each other, emphasis instead being placed upon clearly illustrating the principles of the present invention.

FIG. 1 is a schematic view illustrating an exemplar digital camera in which an embodiment of the system and method for capturing and embedding high-resolution still image data in a video data stream resides.

FIG. 2A is a graphical illustration of an exemplar video data stream illustrating an embodiment of the system and method for capturing and embedding high-resolution still images in a video data stream.

FIG. 2B is a graphical illustration of an exemplar video data stream illustrating an alternative embodiment of the system and method for capturing and embedding high-resolution still images in a video data stream.

FIG. 3A is a graphical illustration showing the embedding of high-resolution still image data into a low-resolution video data stream.

FIG. 3B is a graphical illustration showing an alternative embodiment of the incorporation of high-resolution still image data into a low-resolution video data stream.

FIG. 4 is a flow chart illustrating the operation of one embodiment of the system and method for capturing and embedding high-resolution still data in a video data stream.

### DETAILED DESCRIPTION OF THE PREFERRED EMBODIMENT

The embodiments of the invention described below are applicable to any digital video recorder with which it is desired to capture and embed high-resolution still images in a video data stream. The system and method for capturing and embedding high-resolution still images using a digital video recorder can be implemented in hardware, software, firmware, or a combination thereof. In the preferred embodiment(s), the invention is implemented using firmware that is executed by an application specific integrated circuit (ASIC). In an alternative implementation, embodiments of the invention may be implemented using a combination of hardware and software that is stored in a memory and that is executed by a suitable instruction execution system. The hardware portion of the invention can be implemented with any or a combination of the following technologies, which are all well known in the art: a discrete logic circuit(s) having logic gates for implementing logic functions upon data signals, an application-specific integrated circuit (ASIC) having appropriate combinational logic gates, a programmable gate array(s) (PGA), a field-programmable gate array (FPGA), etc.

The software portion of the invention can be stored in one or more memory elements and executed by a suitable general purpose or application specific processor. The program for capturing high-resolution still images using a digital video camera, which comprises an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

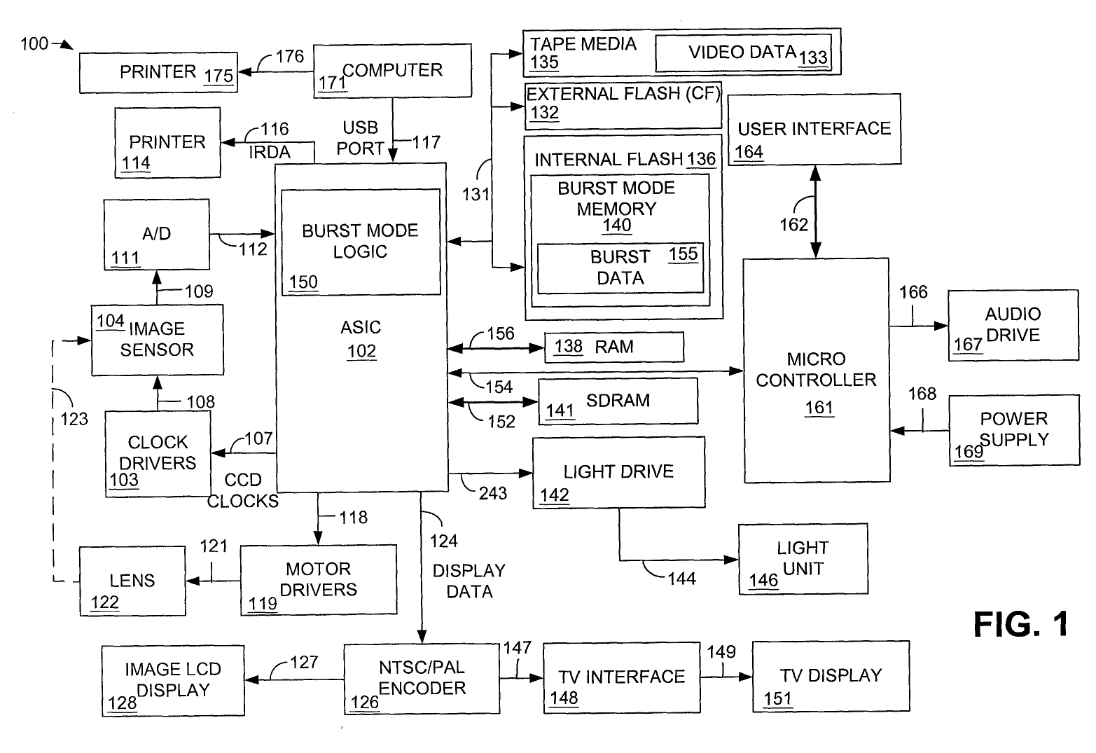

FIG. 1 is a block diagram illustrating a digital camera 100 constructed in accordance with an embodiment of the invention. In the implementation to be described below, the digital camera 100 is a digital video recorder that includes an application specific integrated circuit (ASIC) 102. The ASIC 102 executes the burst mode logic 150, which, when directed by a user of the camera, enables the digital camera 100 to enter a “burst,” or “print capture” mode of operation. When in burst mode, the camera 100 captures high-resolution still images. The burst mode of operation can be entered during execution of a normal “video mode” of operation, during which video image data is captured by the digital camera 100.

When switched to burst mode, the normal video mode is suspended while still image data is captured and saved by a memory element (to be described below) in the digital camera 100. In an alternative embodiment, the burst mode logic may be implemented in software, which can be stored in a memory and executed by a suitable processor. For example, aspects of the invention can be embodied in software that is stored in the internal flash memory (to be described below) and executed by a suitable microprocessor.

The ASIC 102 controls the function of various aspects of the digital camera 100. The ASIC 102 couples to a printer 114 via, for example, an infrared (IR) connection 116 and also includes a universal serial bus (USB) port 117, for connection to other processing devices, such as a personal computer 171. The ASIC 102 couples to a clock driver element 103 via connection 107. The clock driver element 103 couples via connection 108 to an image sensor 104. The image sensor 104 may be a charge coupled device (CCD) or a complementary metal oxide semiconductor (CMOS) sensor that is capable of detecting light from a lens 122 and converting the captured light into an electrical signal. Indeed, the image sensor 104 can be any image sensor capable of capturing light and converting the light to an electrical signal.

The image sensor 104 captures an image of a subject (not shown) and sends an electronic representation of this image via connection 109 to an analog-to-digital converter 111. The analog-to-digital converter 111 converts the analog signal received from the image sensor 104 into a digital signal and provides this digital signal as image data via connection 112 to the ASIC 102 for image processing.

The ASIC 102 couples via connection 118 to one or more motor drivers 119. The motor drivers 119 control the operation of various parameters of the lens 122 via connection 121. For example, zoom and focus operations can be controlled by the motor drivers 119. The connection 123 between the lens 122 and the image sensor 104 is shown as a dotted line to illustrate the operation of the lens 122 focusing on a subject and communicating that information to the image sensor 104, which captures the image provided by the lens 122.

The ASIC 102 also sends display data via connection 124 to a national television system committee (NTSC)/phase alternate line (PAL) encoder 126. The encoder 126 converts the display data from the ASIC 102 into a signal that can be shown on image display 128 via connection 127. The encoder 126 also converts the output of the ASIC 102 on connection 124 to information that can be supplied to a television interface 148 via connection 147. The image display 128, which can be, for example a liquid crystal display (LCD) or other display, displays the captured image to the user of a digital camera 100, and is typically the display located on the digital camera 100. The TV interface 148 is typically one or more connections and/or interfaces that allow the output of the ASIC 102 to be displayed on a conventional television 151 via connection 149.

The ASIC 102 also supplies a drive signal via connection 143 to the light drive element 142. The light drive element 142 activates a light unit 146 via connection 144 when it is determined that conditions suggest additional illumination.

The ASIC 102 couples to a microcontroller 161 via connection 154. The microcontroller 161 can be a specific or a general purpose microprocessor that controls the various operating aspects and parameters of the digital camera 100. For example, the microcontroller 161 is coupled to a user interface 164 via connection 162. The user interface 164 may include, for example but not limited to, a keypad, one or more buttons, a mouse or pointing device, a shutter release, and any other buttons or switches that allow the user of the digital camera 100 to input commands. The microcontroller 161 also couples via connection 166 to an audio drive 167. The audio drive provides audible signals to the user of the digital camera 100. The microcontroller 161 also couples via connection 168 to a power supply 169. The power supply 169 may be, for example but not limited to, one or more batteries, an AC adapter, or any other type of power supply for powering the digital camera 100.

The ASIC 102 also couples to one or more memory elements, to be described below with particular reference to the type of memory to which the ASIC 102 is coupled over various connections. It should be noted that while specific types of memory are denoted below, the digital camera 100 may employ various other types of memory not specifically described herein. For example, the various memory elements may comprise volatile, and/or non-volatile memory, such as, for example but not limited to, random access memory (RAM), read-only memory (ROM), and flash memory. Furthermore, the memory elements may be either internal to the digital camera 100 or may be removable memory media, and may also comprise memory distributed over various elements within the digital camera 100. All such memory types are contemplated to be within the scope of the invention.

The ASIC 102 couples to static dynamic random access memory (SDRAM) 141 via connection 152. The SDRAM 141 houses the various software and firmware elements and components (not shown) that allow the digital camera 100 to perform its various functions. The ASIC 102 also couples to RAM 138 via connection 156. The RAM 138 generally provides temporary storage for the images captured by the image sensor 104.

The ASIC 102 also couples via connection 131 to an external flash memory 132, an internal flash memory 136, and a tape media 135. The tape media 135 can be any available tape format used to store captured video data 133. Well known formats for tape media 135 include, but are not limited to, VHS-C, mini-DV, HI-8, etc. Further, as will be described in detail below, the internal flash memory 136 is one possible storage location for still images captured while the digital camera 100 is operating in burst mode.

In accordance with an embodiment of the invention, when a user wishes to capture a high-resolution still image using the digital camera 100, the user activates appropriate commands on the user interface 164 to enter burst mode operation. The burst mode of operation may be entered while the digital camera 100 is operating in a video mode and capturing video data, or can be placed in the burst mode from an idle condition. Regardless, when in burst mode, the digital camera 100 captures high-resolution still image data and transfers this data to the burst mode memory 140.

When the digital camera 100 is operating in burst mode, the burst mode memory 140 is used to store the captured high-resolution still image data as burst mode data 155 until the burst mode memory 140 is full. Then, the digital camera 100 can automatically shut off, or return to the video mode of operation. In this manner, the user is able to capture high-resolution “print quality” still image data while preserving the ability to capture video image data. The burst data 155 can be used to render a photographic image using a printer 175 coupled to the computer 171. Further, although illustrated as saved in the internal flash memory 136, the burst data 155 can be saved to the external flash memory 132, or other memory. In this manner, the burst data can be removed from the digital camera 100 and transferred to an external processing device, such as a computer, printer, or another device capable of receiving the burst data 155 and rendering a displayed or printed image.

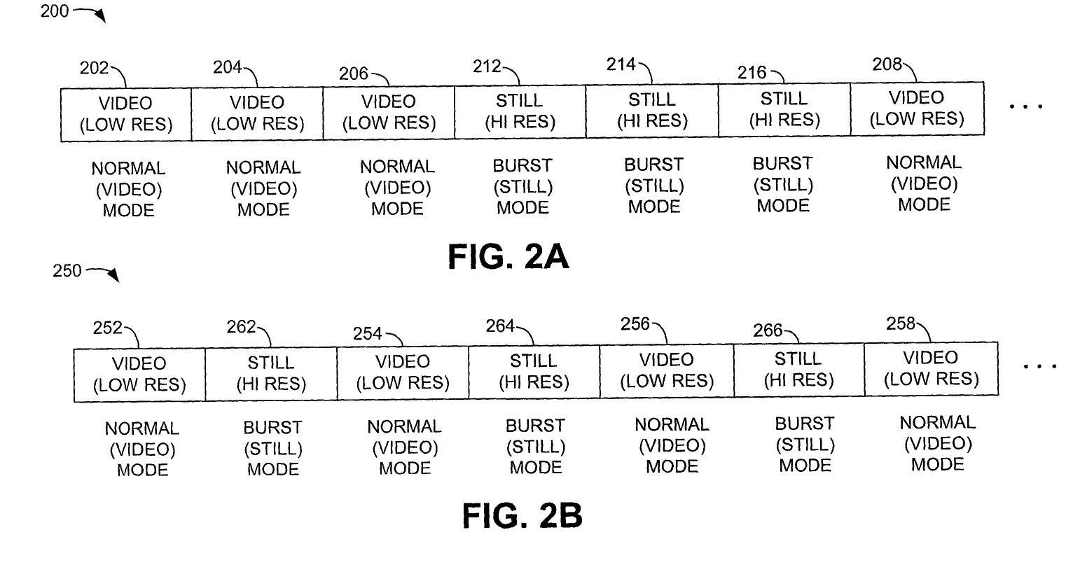

FIG. 2A is a graphical illustration of an exemplar video data stream 200 illustrating an embodiment of the system and method for capturing and embedding high-resolution still images in a video data stream. The video data stream 200 includes a plurality of low-resolution video frames 202, 204, 206 and 208 that can be stored on the tape media 135 (FIG. 1) as video data 133. The video frames 202 through 208 are captured at a relatively low-resolution and at a frame rate of approximately 30 frames per second. However, as described above, this resolution is typically insufficient to produce a high quality printed still image. Therefore, when a user desires to capture an image from which a high quality still image is desired, the user enters a “burst,” or “print capture” mode. This high-resolution mode can be entered by the user entering an appropriate command via the user interface 164 of FIG. 1. As shown in FIG. 2A, after the user has entered the appropriate burst mode command, one or more high-resolution still image data frames are captured and embedded into the video data stream 200.

As shown in FIG. 2A, the high-resolution still frames 212, 214 and 216 are embedded into the video data stream 200 between video frame 206 and video frame 208. When the digital camera 100 (FIG. 1) is placed in this “high-resolution burst mode,” the image data represented by the still image frames 212, 214 and 216 is saved in the burst mode memory 140 (FIG. 1). These still image data frames 212, 214 and 216 are captured at as high a rate as possible until either the burst mode memory 140 is filled, or the user reverts to video capture mode. If the burst mode memory 140 fills before the user exits the burst mode, the digital camera 100 can automatically revert to the video mode, as illustrated by the video frame 208 that follows the high-resolution still data frame 216.

FIG. 2B is a graphical illustration of an exemplar video data stream 250 illustrating an alternative embodiment of the system and method for capturing and 5 embedding high-resolution still images in a video data stream. The video data stream 250 includes a plurality of low-resolution video frames 252, 254, 256 and 258. The video frames 252, 254, 256 and 258 are captured at a relatively low-resolution and at a frame rate of approximately 30 frames per second. However, as described above, this resolution is generally insufficient to produce a high quality printed still image. Therefore, when a user enters the “burst,” or “print capture” mode, one or more high-resolution still image data frames are captured and alternately embedded with the low resolution video frames into the video data stream 250.

As shown in FIG. 2B, the high-resolution still frames 262, 264 and 266 are alternately embedded into the video data stream 250 between successive video frames 252, 254, 256 and 258. When the digital camera 100 (FIG. 1) is placed in this “high-resolution burst mode,” the image data represented by the still image frames 262, 264 and 266 is saved in, for example, the burst mode memory 140 (FIG. 1). These still image data frames 262, 264 and 266 are captured at as high a rate as possible until either the burst mode memory 140 is filled, or the user reverts to video capture mode. If the burst mode memory 140 fills before the user exits the burst mode, the digital camera 100 automatically reverts to the video mode, as illustrated by the video frame 258 that follows the high-resolution still data frame 266.

The tape media 135 for storing video data and the burst mode memory 140 for storing burst data 155, as illustrated in FIG. 1, are merely representative of, and should not be construed as the only location or memory type that can be used to store the video data stream and the burst data 155. Further, during playback, the burst mode logic 150 can interleave the high-resolution burst data 155 into the low-resolution video data stream either sequentially or non-sequentially. This means that any number of high-resolution frames can be interleaved in any order into the frames that comprise the video data stream.

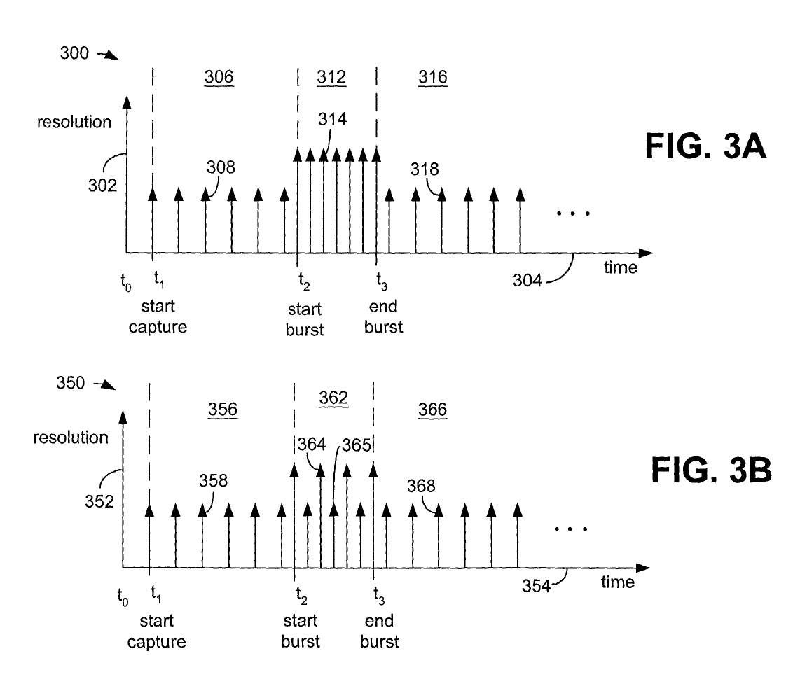

FIG. 3A is a graphical illustration 300 showing the embedding of high-resolution still image data into a low-resolution video data stream. The vertical axis 302 of the graphical representation 300 denotes image resolution while the horizontal axis 304 denotes time. As shown, at a time t₁, video image capture begins, as illustrated using reference numeral 306. During time 306, the digital camera 100 captures video data frames, an exemplar one of which is illustrated using reference numeral 308, at a first resolution and stores the captured video data frames 308 on the tape media 135 (FIG. 1).

At the time t₂, burst mode is entered. During the time after t₂, and denoted using reference numeral 312, the digital camera 100 ceases capturing video data and begins capturing high-resolution still image frames, an exemplar one of which is illustrated using reference numeral 314. During the time period 312, high-quality still image data is captured and saved in the burst mode memory 140, as burst data 155. The burst data 155 is captured and saved in the burst mode memory 140 until either the burst mode memory 140 is full, or until the user decides to revert to video mode.

At time t₃, the burst mode is exited and the digital camera 100 reverts to video capture mode, illustrated using a plurality of captured video frames, an exemplar one of which is illustrated using reference numeral 318.

FIG. 3B is a graphical illustration 350 showing an alternative embodiment of the embedding of high-resolution still image data into a low-resolution video data stream. The vertical axis 352 of the graphical representation 350 denotes image resolution while the horizontal axis 354 denotes time. As shown, at a time t₁, video image capture begins, as illustrated using reference numeral 356. During time 356, the digital camera 100 captures video data frames, an exemplar one of which is illustrated using reference numeral 358, at a first resolution and stores the captured video data frames 358 on the tape media 135 (FIG. 1).

At the time t₂, burst mode is entered. During the time after t₂, and denoted using reference numeral 362, the digital camera 100 begins capturing high-resolution still image frames and embeds the high-resolution still image frames between frames of video data. For example, exemplar still image high-resolution frames 364 are embedded between successive frames of video data, illustrated using reference numeral 365. During the time period 362, high-quality still image data is captured and saved in the burst mode memory 140, as burst data 155. The burst data 155 is captured and saved in the burst mode memory 140 until either the burst mode memory 140 is full, or until the user decides to revert to video mode.

At time t₃, the burst mode is exited and the digital camera 100 reverts to video capture mode, illustrated using a plurality of captured video frames, an exemplar one of which is illustrated using reference numeral 368.

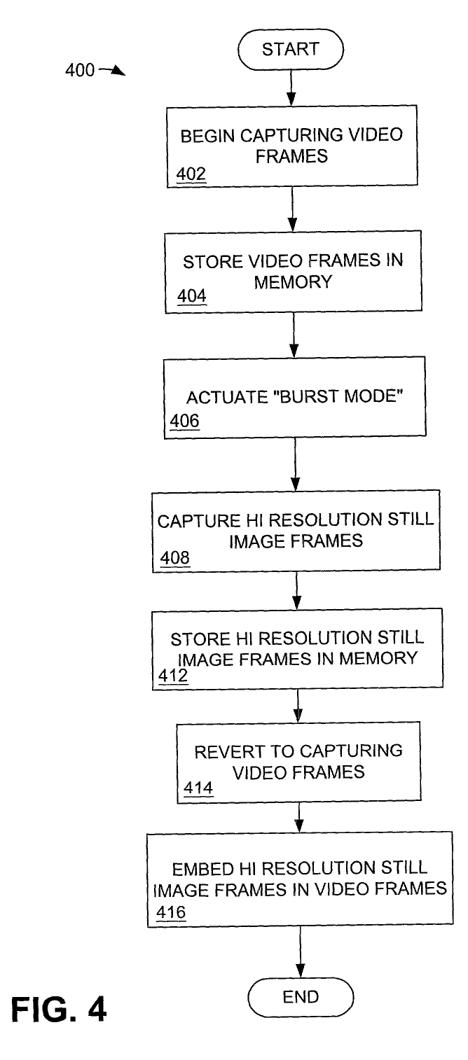

FIG. 4 is a flow chart 400 illustrating the operation of one embodiment of the system and method for capturing and embedding high-resolution still data in a video data stream. In block 402, a user of the digital camera 100 begins capturing video frames. For example, this is analogous to the time period 306 beginning at time t₁ in FIG. 3A. In block 404, the captured video frames, an exemplar one of which is illustrated in FIG. 3A using reference numeral 308, are stored in memory, and more particularly are stored in the tape media 135 of FIG. 1 as video data 133

In block 406, a user of the digital camera 100 enters an appropriate command into the user interface 164 to actuate “burst mode” operation. This corresponds to time t₂ in FIG. 3A. In block 408, the digital camera 100 captures high-resolution still image data frames, represented using reference numeral 314 in FIG. 3A. In block 412 the high-resolution still image data frames are stored in the burst mode memory 140 of FIG. 1. In block 414 the user either enters an appropriate command into the user interface 164 to revert to capturing low-resolution video data frames, or, the burst mode memory 140 of FIG. 1 is filled and the digital camera 100 automatically reverts to capturing low-resolution video frames, as indicated in FIG. 3A using reference numeral 316.

Further, a user of the digital camera 100 can “toggle,” or repeatedly switch between the video mode and the burst mode so that high-resolution still images can repeatedly be captured while continuing to capture video data. In addition, the burst mode can be entered without the digital camera 100 already being in a video capture mode.

It will be apparent to those skilled in the art that many modifications and variations may be made to the preferred embodiments of the present invention, as set forth above, without departing substantially from the principles of the present invention. For example, the system and method for capturing and embedding high-resolution still data in a sequence of video data can be implemented in any digital video recorder. All such modifications and variations are intended to be included herein within the scope of the present invention, as defined in the claims that follow.

What is claimed is:

1. A system for capturing and embedding high-resolution still image data in a sequence of video data, comprising:
an image capture element for capturing a sequence of video data during a first mode of operation, the sequence of video data captured at a first resolution;
a user interface for entering into a second mode of operation, the second mode of operation being at a second resolution, the second resolution being greater than the first resolution; and
a memory for storing data captured at the second resolution.

2. The system of claim 1, wherein the second mode of operation captures data corresponding to still image data.

3. The system of claim 2, wherein the still image data is embedded between frames of video data.

4. The system of claim 2, wherein the still image data has a resolution of at least 640 pixels by 480 pixels.

5. The system of claim 1, wherein the user interface allows toggling between the first resolution and the second resolution.

6. The system of claim 5, wherein the toggling between the first resolution and the second resolution occurs using a single control on the user interface.

7. The system of claim 1, wherein the sequence of video data captured during the first mode of operation is divided into video frames and data generated at the second resolution is divided into still frames, and the video frames and the still frames alternate sequentially.

8. The system of claim 7, wherein the video frames and the still frames alternate non-sequentially.

9. A method for capturing and embedding high-resolution still image data in a sequence of video data, comprising:
capturing a sequence of video data during a first mode of operation, the sequence of video data captured at a first resolution;
entering into a second mode of operation, the second mode of operation being at a second resolution, the second resolution being greater than the first resolution;
capturing data at the second resolution; and
storing the data captured at the second resolution.

10. The method of claim 9, wherein the second mode of operation captures data corresponding to still image data.

11. The method of claim 10, further comprising embedding the still image data between frames of video data.

12. The method of claim 10, wherein the still image data has a resolution of at least 640 pixels by 480 pixels.

13. The method of claim 9, further comprising toggling between the first resolution and the second resolution.

14. The method of claim 13, wherein the toggling between the first resolution and the second resolution occurs using a single control on the user interface.

15. The method of claim 9, further comprising:
dividing the sequence of video data captured during the first mode of operation into video frames;
dividing the data generated at the second resolution into still frames; and
sequentially alternating the video frames and the still frames.

16. The method of claim 15, wherein the video frames and the still frames alternate non-sequentially.

17. The method of claim 9, further comprising:
transferring the data stored at the second resolution to a printing device; and
using the data stored at the second resolution to render a photograph.

18. A digital video camera having a system for capturing and embedding high-resolution still image data in a sequence of video data, comprising:
an image capture element for capturing a sequence of video data during a first mode of operation, the sequence of video data captured at a first resolution;
a user interface for entering into a second mode of operation, the second mode of operation being at a second resolution, the second resolution being greater than the first resolution; and
a memory for storing data captured at the second resolution.

19. The system of claim 18, wherein the second mode of operation captures data corresponding to still image data.

20. The system of claim 19, wherein the still image data is embedded between frames of video data.

21. The system of claim 19, wherein the still image data has a resolution of at least 640 pixels by 480 pixels.

22. The system of claim 18, wherein the user interface allows toggling between the first resolution and the second resolution.

23. The system of claim 22, wherein the toggling between the first resolution and the second resolution occurs using a single control on the user interface.

24. A computer readable media having a program for capturing and embedding high-resolution still image data in a sequence of video data, the program comprising logic for:
capturing a sequence of video data during a first mode of operation, the sequence of video data captured at a first resolution;
entering into a second mode of operation, the second mode of operation being at a second resolution, the second resolution being greater than the first resolution;
capturing data at the second resolution; and
storing the data captured at the second resolution.

25. The program of claim 24, wherein the second mode of operation captures data corresponding to still image data.

26. The program of claim 25, further comprising logic for embedding the still image data between frames of video data.

27. The program of claim 25, wherein the still image data has a resolution of at least 640 pixels by 480 pixels.

28. The program of claim 24, further comprising logic for toggling between the first resolution and the second resolution.

29. The program of claim 28, wherein the toggling between the first resolution and the second resolution occurs using a single control on the user interface.

30. The program of claim 24, further comprising:
logic for dividing the sequence of video data captured during the first mode of operation into video frames;
logic for dividing the data generated at the second resolution into still frames;
and logic for sequentially alternating the video frames and the still frames.

31. The program of claim 30, wherein the video frames and the still frames alternate non-sequentially.

32. The program of claim 24, further comprising:
logic for transferring the data stored at the second resolution to a printing device; and
logic for using the data stored at the second resolution to render a photograph.
